(19) United States
(12) Patent Application Publication
(10) Pub. No.: US 2024/0303176 A1
(43) Pub. Date: Sep. 12, 2024

(54) COMPUTING RESOURCE ALLOCATION MECHANISM TESTING AND DEPLOYMENT

(71) Applicant: Adobe Inc., San Jose, CA (US)

(72) Inventors: Raunak Shah, Pune (IN); Shiv Kumar Saini, Bangalore (IN); Atanu R. Sinha, Bangalore (IN)

(73) Assignee: Adobe Inc., San Jose, CA (US)

(21) Appl. No.: 18/178,715

(22) Filed: Mar. 6, 2023

(51) Int. Cl. G06F 11/34; G06F 9/50

(52) U.S. Cl. CPC G06F 11/3442; G06F 9/5077

(57) ABSTRACT

A computing resource allocation system receives entity resource usage data describing computing resource usage of an executable service platform by an entity as part of a first allocation generated using a first allocation mechanism. A computing resource allocation system generates an entity resource model based on the entity resource usage data of the computing resource usage of the executable service platform as part of the first allocation mechanism. A computing resource allocation system simulates computing resource usage of the executable service platform by the entity as part of a second allocation mechanism based on the entity resource model and the entity resource usage data. A computing resource allocation system estimates a second allocation to provide to the entity based on the simulating.

### BACKGROUND

Service provider systems have been developed to provide a variety of computing services available to client devices over a network. An example of this is implementation of “the cloud” in which hardware and software resources of the service provider system are made available over a network to various entities to perform desired computational tasks. A wide variety of types of computing resources are made available via the service provider system to an entity, thereby challenging the entity's ability to manage access to appropriate computing resources by client devices associated with the entity.

Further, access to the computing resources is also challenged when obtained by an enterprise system for entities associated with the enterprise system, e.g., as a pool of computing resources. Examples of these challenges include unforeseen/unpredictable variations in amounts of computing resources requested by the entities, desire for real-time resource allocations, and lack of accuracy in the requests from the entities for access to the computing resources.

### SUMMARY

Testing and deployment techniques of a computing resource allocation mechanism are described that are used to control access and implementation of computing resources. To do so, testing functionality is implemented that is usable to test an allocation mechanism and compare operation of the allocation mechanism with another allocation mechanism (e.g., a currently implemented allocation mechanism) before deployment. Allocation mechanisms and testing of these mechanisms is performable in a variety of ways, including use of an incentive compatible behavior modeled using virtual tokens that penalize inefficiencies and lower utilization while also addressing demand uncertainty by entities that request an allocation of computing resources from the service provider system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ computing resource allocation mechanism testing and deployment techniques described herein.

FIG. 2 depicts a system in an example implementation in which virtual tokens are utilized by an enterprise system in managing access to computing resources allocated to the enterprise system.

FIG. 3 depicts a system in an example implementation showing operation of a resource testing module and resource allocation module of FIG. 2 in greater detail as testing a resource allocation mechanism and subsequently deploying the resource allocation mechanism.

FIG. 4 is a flow diagram depicting a procedure in an example implementation of computing resource allocation mechanism testing and deployment.

FIG. 5 depicts a system in an example implementation showing operation of a simulation module of FIG. 4 in greater detail.

FIG. 6 depicts an example implementation of output of the evaluation data of FIG. 5 in a user interface.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

### Overview

Service provider systems are configured to provide access to a variety of types of computing resources “in the cloud” using hardware and software resources of an executable service platform. Access to computing resources is made available to entities in a variety of different ways, examples of which include compute instances (e.g., interruptible and uninterruptable compute instances), access to particular hardware functionality such as graphics processing unit cores, access to compute resources delineated using virtual machines, and so forth. Accordingly, entities requesting access to the computing resources are challenged with determining which computing resources are appropriate to the entity, inaccuracies of which result in wasted resources, excessive power consumption, and so forth.

Management of this access is challenged by an enterprise system that acquires access to these resources for entities that are associated with the enterprise system, e.g., employees of a corporation, students at a school, and so forth. Resource access, for instance, is made available by specifying an amount of time particular hardware resources as well as an amount of the hardware resources to be acquired, e.g., an amount of access a particular number of cores of a particular number of graphics processing units. Consequently, management of an amount of computing resources to acquire by the enterprise system presents additional challenges and as such are prone to further inefficiencies.

Further, client devices associated with the entity utilize different amounts and types of computing resources, which also vary over time. A data scientist, for instance, when training a machine-learning model may consume a significant amount of computing resources over an initial interval of time and then have that consumption reduced when using the trained model over a subsequent interval of time. Consequently, inaccuracies and inefficiencies often occur in real world scenarios due to requests for an amount of computing resources that are not subsequently used. Accordingly, a computing resource allocation system that is tasked with managing resource allocation by the enterprise system is challenged by a variety of different factors that have a direct effect of computational resource efficiency, power consumption, network bandwidth, and so forth.

To address these technical challenges, techniques are described for testing and deployment of a computing resource allocation mechanism used to control access and implementation of computing resources. These techniques, for instance, support use by an enterprise system in managing access to computing resources obtained from a service provider system to entities associated with the enterprise system. To do so, testing functionality is implemented that is usable to test an allocation mechanism and compare operation of the allocation mechanism with another allocation mechanism (e.g., a currently implemented allocation mechanism) before deployment. This functionality provides an ability to stress test the allocation mechanism for stability before deployment and thus reduces a potential for downside computational and resource inefficiencies when implemented using conventional A/B testing. Allocation mechanisms and testing of these mechanisms is performable in a variety of ways, including use of an incentive compatible behavior modeled using virtual tokens that penalize inefficiencies and lower utilization while also addressing demand uncertainty by entities that request an allocation of computing resources from the service provider system.

In an example, an enterprise system provides access to entities through respective client devices (e.g., using respective user accounts) to computing resources obtained from a service provider system. The enterprise system, for instance, obtains permission to access a pool of computing resources from the service provider system, e.g., as compute instances, GPU cores, virtual machines, and so forth. The enterprise system then allocates access by respective entities to the computing resources using a first allocation mechanism, e.g., “each entity gets a total amount of computing resources requested.” Resource usage data is then collected by the enterprise system by monitoring computing resources usage by respective entities and generating the data as describing this usage.

The enterprise system then generates an entity resource model (e.g., per entity) that models computing resource usage by the entity as managed by the first allocation mechanism based on the entity resource usage data. The entity resource model is then used by the enterprise system to generate a measure of effectiveness of a second allocation mechanism “in the future.” The second allocation mechanism, for instance, specifies “allocate a proportion of computing resources specified in a request based on a proportion of computing resources used with respect to an amount requested by the entity in the past.” Through use of the model, the enterprise system determines an effectiveness of the second allocation mechanism while avoiding costs and downsides of conventional A/B testing techniques that directly affect operation of the enterprise system in the real world.

To do so, the enterprise system in one example models computing device usage using virtual tokens that are representative of the varying computing device resource types, e.g., interruptible instances, uninterruptible instances, a number of GPUs, etc. The enterprise system then provides a mechanism that encourages a resource request (e.g., an “ask”) that has increased likelihood of corresponding to an amount of computing resources used in practice. As a result, the enterprise system is configured to address resource request inaccuracies and lower utilization, while accounting for demand uncertainty. Further discussion of these and other examples is included in the following discussion and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Computing Resource Allocation Environment

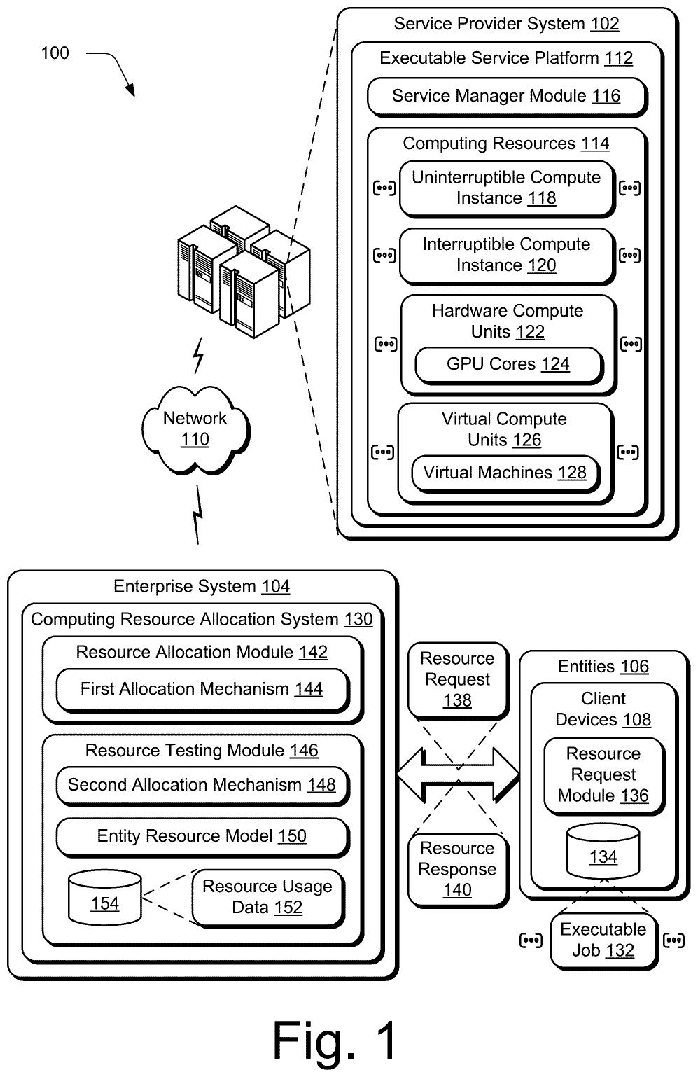

FIG. 1 is an illustration of a digital medium environment 100 in an example implementation that is operable to employ computing resource allocation mechanism testing and deployment techniques described herein. The illustrated environment 100 includes a service provider system 102, an enterprise system 104, as well as entities 106 and associated client devices 108 that are communicatively coupled, one to another, via a network 110. Computing devices that implement the service provider system 102, the enterprise system 104, and the client devices 108 of the entities 106 are configurable in a variety of ways.

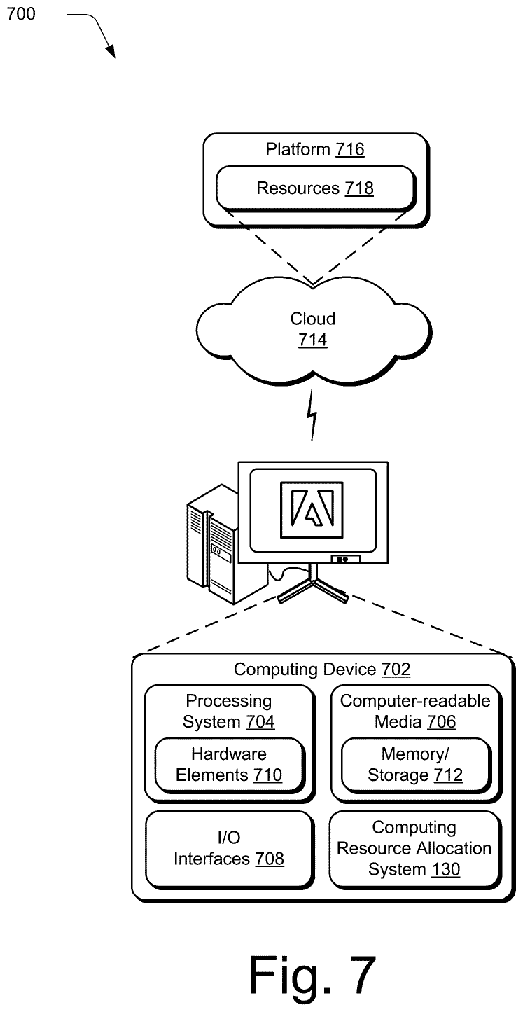

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, a computing device is also representative of a plurality of different devices, such as multiple servers utilized by a business to perform operations “over the cloud” as illustrated for the service provider system 102 and as described in FIG. 7.

The service provider system 102 includes an executable service platform 112 of hardware and software resources represented as computing resources 114. The executable service platform 112, for instance, is configured to provide digital services “in the cloud” that are accessible by the client devices 108 via the network 110 through execution by of the executable service platform 112. Thus, the executable service platform 112 provides an underlying infrastructure to manage execution of jobs and storage of associated data, e.g., provided by the client devices 108.

The executable service platform 112 supports numerous computational and technical advantages, including support of an ability of the service provider system 102 to readily scale resources to address wants of the enterprise system 104 and client devices 108 of the entities 106. Thus, instead of incurring an expense of purchasing and maintaining proprietary computer equipment for performing certain computational tasks, cloud computing provides the client devices 108 and enterprise system 104 with access to a wide range of hardware and software resources so long as the client has access to the network 110.

A service manager module 116 of the executable service platform 112 is implemented to portion and mange access to computing resources 114 of the executable service platform 112. This is performable in a variety of ways. In a first example, portioning of computing resources 114 is implemented using uninterruptible compute instances 118 and interruptible compute instances 120. A “compute instance” refers to a quantum (i.e., portion) of a virtual machine or processing environment provided remotely over a network 110, e.g., via on one or more servers or other computing devices including virtual processors. Execution of compute instances is dynamic, which permits any number of servers (e.g., virtually or physically) to be combined on demand to implement the executable service platform and to avoid processing delays or interruptions. As such, compute instances are freely allocated and can span multiple machines to achieve maximum or increased utilization of the available computational resources. The compute instances also reduce downtime associated with servicing hardware and software resources, whether it be servers or network equipment. For example, a compute instance is moveable from one physical machine to another without a loss of availability and permits seamless transfers of data from one machine to another.

An uninterruptible compute instance 118 is configured such that a lifecycle of the instance is controllable by the client device 108 or enterprise system 104. Lifecycle control includes when to launch, stop, reboot, hibernate, start, terminate, and so forth. Examples of uninterruptible compute instances 118 include reserved virtual machine instances and on-demand instances available from Microsoft Azure®, Amazon Web Services® (AWS), and so on.

Interruptible compute instances 120, on the other hand, are configured to provide access to excess capacity of the executable service platform 112 of the service provider system 102. This accessibility is provided at a reduced cost as opposed to uninterruptible compute instance 118. However, control of the lifecycle of the interruptible compute instance 120 is maintained at the service provider system 102. Examples of interruptible compute instances 120 include volatile instances and spot instances available from Microsoft Azure®, Amazon Web Services® (AWS), and so on.

In another example, computing resources 114 are portioned as specified hardware compute units 122, to which, access is provided for a corresponding amount of time. Graphics processing units (e.g., GPU cores 124), for instance, are “leased” for access over a period of time to train a machine-learning model. Other examples of hardware compute units 122 include central processing units, quantum processors, application specific integrated circuits, and so forth.

In a further example, computing resources 114 are portioned as virtual computing units 126 of corresponding virtual machines 128, e.g., virtual servers. A virtual machine 128 emulates functionality of a computing device by running on a “host” in support of specific operating systems, architectures, and so forth which may be “sandboxed” from access by other virtual machines. Access to the virtual compute units 126 and virtual machines 128 is also manageable by the service manager module 116 in a variety of ways, e.g., for a corresponding amount of time. A variety of other examples of computing resources 114 are also contemplated.

In the illustrated example, the enterprise system 104 employs a computing resource allocation system 130 to obtain an allocation of computing resources 114 from the service provider system 102. The resource allocation system 130 is then used to control access to that allocation by entities 106 associated with the enterprise system 104, e.g., as employees of a corporation, students from a school, users of a third-party platform (e.g., customers), and so forth. The client devices 108, for instance, include executable jobs 132 (illustrated as stored in a storage device 134) for execution by the computing resources 114 of the executable service platform 112. A resource request module 136 is configured to generate a resource request 138 (e.g., an “ASK”) for communication to the enterprise system 104 and receive a resource response 140 providing an entity-specific allocation of the computing resources 114 obtained by the computing resource allocation system 130 to the entity 106.

The computing resource allocation system 130 includes a resource allocation module 142 that employs a first allocation mechanism 144 to manage access to the computing resources 114 allocated to the enterprise system 104, e.g., at runtime in real time. The first allocation mechanism 144 is configurable in a variety of ways to manage this access, an example of which is performed “per entity” associated with the enterprise system 104. The first allocation mechanism 144 is also configurable to employ logic specifying varying degrees of complexity in order to manage this access. The logic, for instance, is configured to control access and allocations based on an amount of computing resources included in the allocation, priority of types of operations to be performed (e.g., machine-learning training versus conventional processing), and so forth.

Allocation mechanisms encounter a variety of challenges in efficient management of access to the computing resources 114 by the entities 106. Consider an example in which the enterprise system 104 allocates computing resources to the entities 106 as employees of the enterprise. In some instances, access to a significant portion of the computing resources 114 allocated to the enterprise system 104 are controlled by the entities 106. In one instance, entities 106 are allocated a common pool of computing resources 114 guided by a common task that is to be collectively performed.

In another instance, individual entities 106 desire computing resources 114 commensurate with a particular task, e.g., to train a machine-learning model. As previously described, an amount of computing resources 114 desired by the entities 106 typically varies over time. Consequently, in this instance an individual entity plans for a projected amount of computing resources 114 to be used at a future point in time and generates the resource request 138 as an “ASK” for those resources. For example, the entity requests sufficient computing resources 114 to run multiple executable jobs 132 as machine-learning jobs using multiple GPU cores 124. As a result, in this instance utilization of the computing resources 114 is highly dependent on the entity 106 and accuracy of the entity in predicting the amount of computing resources 114 to be used. Besides individual entity-level requests, the resource allocation module 142 also supports group-level requests, where entities included in the group request computing resources 114 for a shared project.

In order to address these challenges, the computing resource allocation system 130 employs a resource testing module 146. The resource testing module 146 is configured as a testing framework for implementing a practicable market-based approach to computing resource allocation. As a result, the computing resource allocation system 130 is configured to allocate computing resources 114 to entities 106 in support of lower wastage, decreased power consumption, and increased efficiency for the executable service platform 112, the enterprise system 104, and the entities 106.

The resource testing module 146, for instance, is configured to test a second allocation mechanism 148. Based on this testing, an entity resource model 150 is generated for modeling computing resource usage of respective entities 106. The modeling is based on resource usage data 152 stored in an storage device 154 generated as a result of use of the first allocation mechanism 144 by the resource allocation module 142 “in the real world.”

In an implementation, testing performed by the resource testing module 146 is used to implement a market-based approach to resource allocation. Entities 106, for instance, request access to amounts of computing resources 114 based on an expectation of future demand, which is practice is difficult to perform. Consequently, entities in the real world typically request an amount of resources that is greater than an expected amount of computing resources to be used, resulting in wastage and low utilization.

Accordingly, in an example the resource testing module 146 implements a matching-market based technique that employs incentives for both the entities 106 and the enterprise system 104. These techniques address the above challenges through empirical testing of alternative allocation mechanisms (e.g., the second allocation mechanism 148) from existing allocation mechanisms (e.g., the first allocation mechanism 144) without affecting operation of the computing resources 114 as involved in conventional A/B testing scenarios. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Computing Resource Allocation Mechanism Testing and Deployment

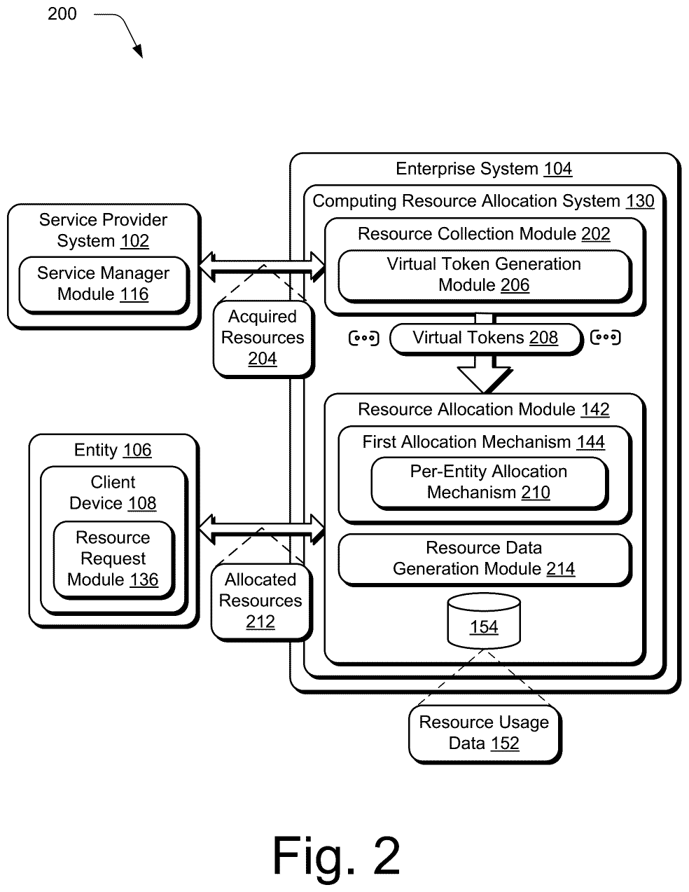

FIGS. 2-6 describe testing and deployment techniques for computing resource allocation mechanism that are implementable utilizing the previously described systems and devices. In conventional techniques, A/B testing is used to determine suitability of allocation mechanisms. However, as executable service platform 112 usage continues to expand A/B testing is no longer viable because of a potential number of mechanisms to test is large relative to a potential benefit of those mechanisms.

Accordingly, the resource testing module 146 is utilized to support testing techniques for alternative allocation mechanisms based on observational data generated based on a current allocation mechanism. These testing techniques also address technical challenges involved in recognizing that allocation mechanisms result in changes to corresponding entities request behaviors (e.g., the ask) and consequently observational data generated based on that mechanism.

FIG. 2 depicts a system 200 in an example implementation in which virtual tokens are utilized by an enterprise system in managing access to computing resources allocated to the enterprise system. In this example, the computing resource allocation system 130 includes a resource collection module 202 to acquire computing resources from the service provider system 102, illustrated as acquired resources 204. The types of computing resources acquired by the resource collection module 202 may take a variety of forms as previously described in relation to FIG. 1, e.g., compute instances such as uninterruptible compute instances 118 and interruptible compute instances 120, hardware compute units 122, virtual computing units 126, and so forth.

The resource collection module 202 then employs a virtual token generation module 206 to generate virtual tokens 208 as representative of quanta of the acquired resources 204. Generation of the virtual tokens 208 is usable to represent the quanta of resources in a variety of ways. Examples of virtual token 208 configurations include use of particular types of virtual tokens for particular types of computing resources 114, as an abstraction of computing resources 114 as a whole (e.g., is agnostic to type), configuration such that different types of resources have different prices in units of credits/hour, and so forth. The virtual tokens 208 are then passed as an input to the resource allocation module 142.

The resource allocation module 142 in this example employs a first allocation mechanism 144 based on the virtual tokens 208 to allocate resources. An example of this mechanism is illustrated as a per-entity allocation mechanism 210 in which amounts of virtual tokens 208 (and corresponding computing resources 114) are allocated on a per-entity basis as allocated resources 212. A resource data generation module 214 is also employed by the computing resource allocation system 130 to generate resource usage data 152 that describes computing resource usage by the entities 106 of the computing resources 114 of the executable service platform 112.

In one example, virtual tokens 208 are employed using a technique in which entities 106 are allocated a number of virtual tokens 208 to be used in a specified period of time. Through use of virtual tokens 208, the resource allocation module 142 is configured to allocate virtual tokens 208 in a way that incentivizes the entities 106 to request an amount of computing resources that is close to an amount of resources that are actually used. The resource allocation module 142 also supports use of a framework to evaluate performance of different allocation mechanisms, examples of which in the following include virtual token wastage of credits and average GPU utilization.

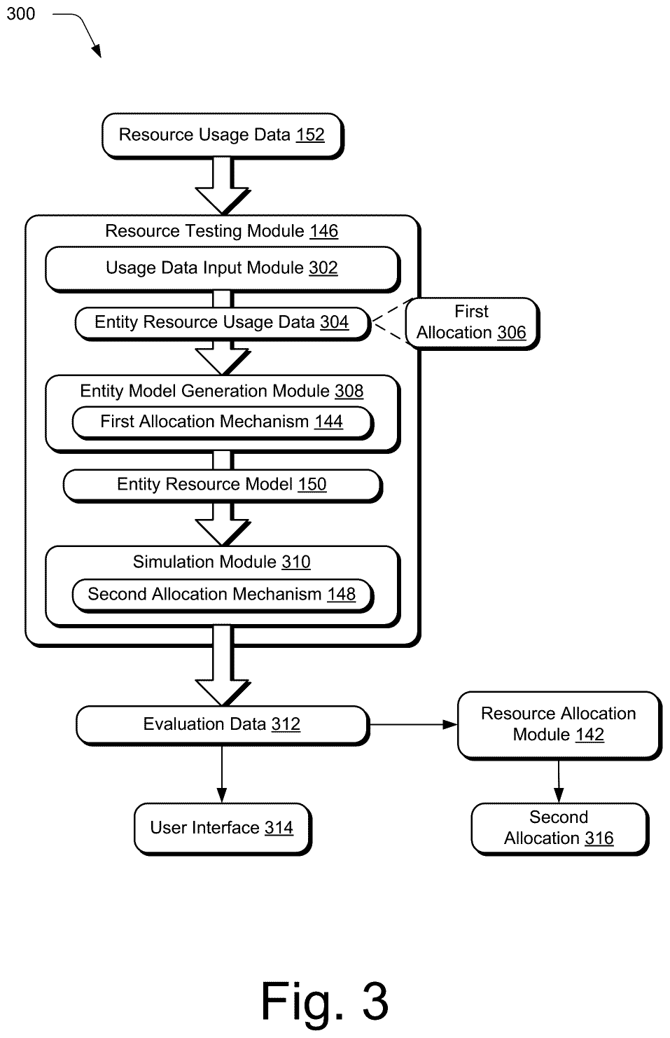

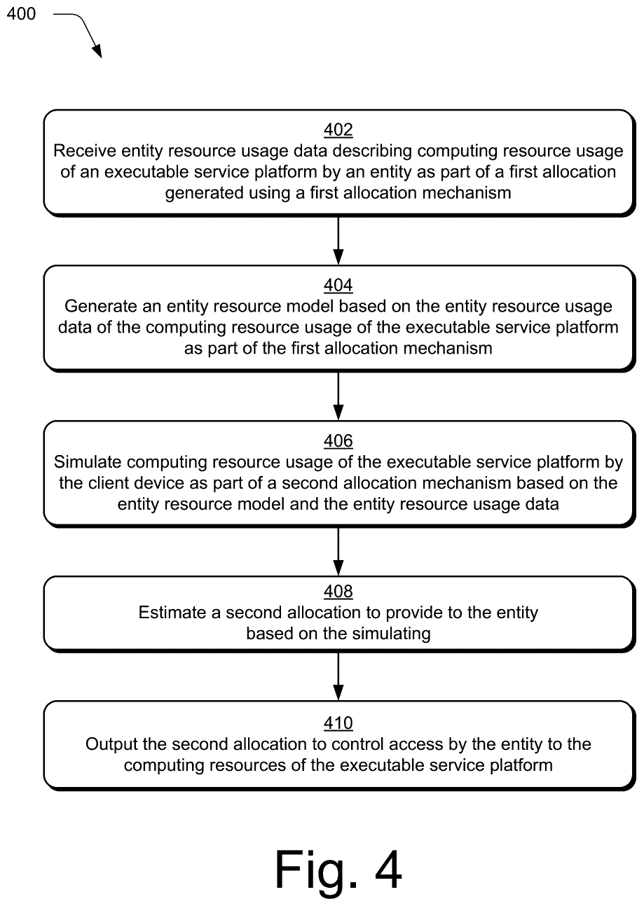

FIG. 3 depicts a system 300 in an example implementation showing operation of the resource testing module 146 and resource allocation module 142 in greater detail as testing a resource allocation mechanism and subsequently deploying the resource allocation mechanism. FIG. 4 depicts a procedure 400 in an example implementation of computing resource allocation mechanism testing and deployment. Aspects of the procedure are implemented in hardware, firmware, software, or a combination thereof. The procedure is shown as a set of blocks that specify operations performed by one or more devices and are not necessarily limited to the orders shown for performing the operations by the respective blocks. In the following discussion reference to the procedure 400 of FIG. 4 is made in parallel with the system 300 of FIG. 3.

To begin in this example, a usage data input module 302 obtains resource usage data 152, e.g., from the storage device 154 of FIG. 2. From this, the usage data input module 302 generates entity resource usage data 304 describing computing resource 114 usage of an executable service platform 112 by an entity 106 as part of a first allocation 306 generated using a first allocation mechanism 144 (block 402). Thus, in this example the entity resource usage data 304 is generated “per entity,” which is usable to describe individuals, groups, and so forth.

An entity model generation module 308 is then employed to generate an entity resource model 150 based on the entity resource usage data 304 of the computing resource usage of the executable service platform 112 as part of the first allocation mechanism 144 (block 404). To do so in the following example, the following notation is utilized for a set of events at a first time period “sₜ” and moving to a set of events at a second time period “t+1”, “sₜ₊₁.” Each of the values described in the following example (except utilization) are denoted in terms of virtual tokens 208 as follows:
· “Pₜ₊₁”=virtual tokens 208 provisioned by the first allocation mechanism 144;
“dₜ₊₁”=realized demand, which are the virtual tokens 208 actually used in time period “t+1;”
“Dₜ₊₁”=distribution over the demand in virtual tokens 208;
“aₜ₊₁”=an amount of virtual tokens 208 specified in the resource request 138 from the entity;
“sₜ₊₁”=state;
“uₜ₊₁=dₜ₊₁/Pₜ₊₁”=utilization of virtual tokens 208 (e.g., as fraction between zero and one); and
State “sₜ₊₁=f(sₜ, aₜ₊₁).”

Accordingly, a sequence of events that occurs within a time period is modeled as follows. At time period “t,” an entity is at state “sₜ” and observes a distribution of demand in a next period “t+1”, “Dₜ₊₁.” The entities 106 and the resource allocation module 142 also maintain and remember data describing past utilization of the computing resources 114. Accordingly, each entity is aware of an amount of virtual tokens requested (e.g., “aₖ”), an amount of virtual tokens actually used (e.g., “dₖ”), and an amount of virtual tokens 208 provisioned by the first allocation mechanism 144 for previous intervals of time, i.e., before “t+1.” The resource allocation module 142 is also aware of an amount of virtual tokens requested (e.g., “aₖ”), an amount of virtual tokens actually used (e.g., “dₖ”), and an amount of virtual tokens 208 provisioned by the first allocation mechanism 144 for previous intervals of time.

The entity 106 then generates a resource request 138 as an “ASK” for an amount “aₜ₊₁” of virtual tokens 208 based on a known distribution of a demand in the virtual tokens “Dₜ₊₁.” The resource allocation module 142 observes the resource request 138 and in particular the amount “aₜ₊₁” of virtual tokens 208. The resource allocation module 142 then allocates (i.e., provisions) an amount of virtual tokens 208 of “Pₜ₊₁” based on the amount “aₜ₊₁” of virtual tokens 208 and the entity resource usage data 304. Subsequently, actual demand “dₜ₊₁” is realized and utilization “uₜ₊₁=dₜ₊₁/Pₜ₊₁.” This process continues to state “sₜ₊₁” and repeats.

The entity resource model 150 is then passed as an input to a simulation module 310. The simulation module 310 is then employed to simulate computing resource usage of the executable service platform 112 by the entity as part of a second allocation mechanism 148 based on the entity resource model 150 and the entity resource usage data 304 (block 406). Evaluation data 312 generated based on this simulation is then usable in a variety of ways. In a first example, the evaluation data 312 is output in a user interface 314. Therefore, a data scientist may view an outcome of the second allocation mechanism 148 before actual deployment.

In a second example, the evaluation data 312 is output for deployment by a resource allocation module 142 in estimating a second allocation to provide to the entity based on the simulation (block 408). The second allocation 316 is then output to control access by the entity to the computing resources of the executable service platform (block 410). Further discussion of these examples is included in the following description.

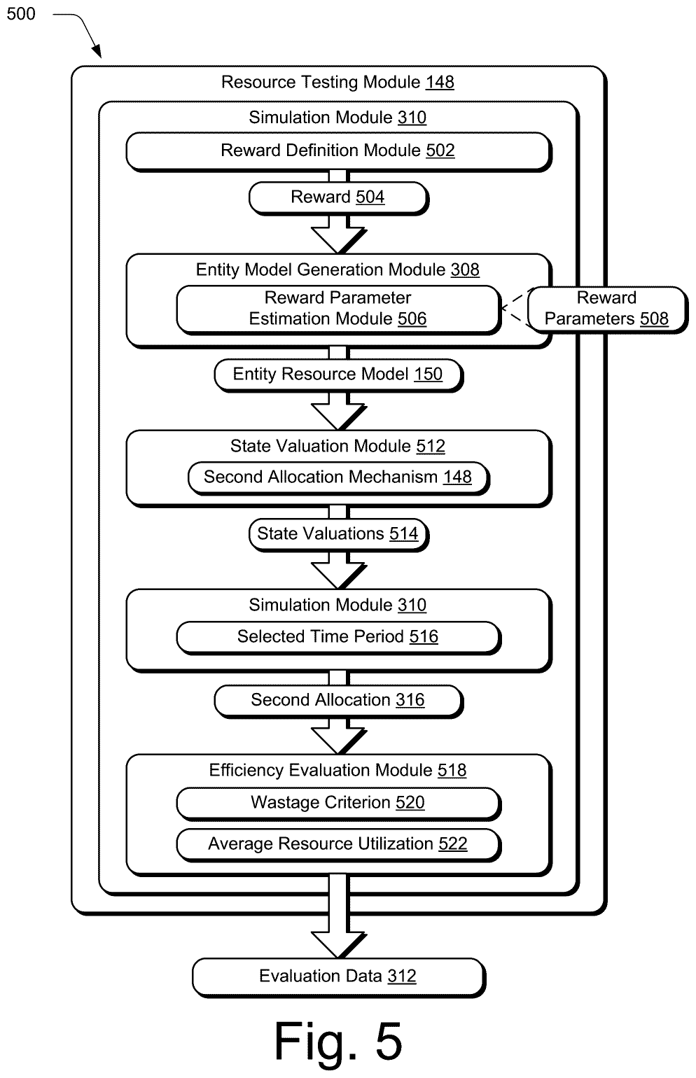

FIG. 5 depicts a system 500 in an example implementation showing operation of a simulation module of FIG. 4 in greater detail. In this example, the simulation module 310 employs a machine-learning model implementing reinforcement learning for simulating access by a respective entity to computing resources 114 of the executable service platform 112. As part of this, states and the action space are modelled using a Markov decision process in which entities take actions that result in a state with the highest valuation.

A single entity is modeled as follows using a Bellman Equation:

V(s)=max_{-a∈A}Σ_{s′}[r(s,a,s′)+γV(s′)]*Pr(s′|s,a)

where, V(s) is value for state s, r(s, a, s′) is reward, A is action space, S is state space, γ the discount factor, and Pr denotes transition probability.
A discrete state space is defined as “sₜ=f(sₜ, aₜ₊₁)” and a demand distribution is defined as “Dₜ˜N(μₜ, σₜ)” where “μₜ” and “σₜ” are computed using past data. Once the parameters of the above Bellman equation are obtained (e.g., function “r(s, a, s′),” “γ,” “Pr(s′|s, a)”), dynamic programming techniques are usable to obtain “V(s)” for a given provisioning mechanism, e.g., See R. Bellman, Dynamic Programming. Princeton University Press, 1957, the entire disclosure of which is hereby incorporated by reference.

Steps included in estimating a value function in order to generate the evaluation data 312 include defining, by a reward definition module 502, an instantaneous reward 504 “r(s, a, s′).” An entity model generation module 308 generates an entity resource model 150 through use of a reward parameter estimation module 506 that is configured to estimate reward parameter 508 on the function “r(s, a, s′)” and a transition matrix “Pr(s′|s, a)” under an allocation mechanism (e.g., the first allocation mechanism 144 which generated the resource usage data 152. From this, a discount factor may be identifiable as further described below. Otherwise, a value of the discount factor is set based on convention.

For an allocation mechanism to be tested (e.g., the second allocation mechanism 148), a state valuation module 512 generates state valuations 514, i.e., “V(s).” The simulation module 310 then estimates the second allocation 316 based on the state valuations 514 that maximizes a value to the entity as well as utilization of the computing resources 114 under the second allocation mechanism 148 for a selected time period 516, e.g., a future time period as described in relation to FIG. 3. The simulation module 310 also includes an efficiency evaluation module 518 that is configured to generate the evaluation data 312 based on a variety of criteria, examples of which include a wastage criterion 520 and an average resource utilization 522 criterion.

In an implementation example, in defining the reward 504 it has been observed that in an allocation mechanism in which each entity is allocated an amount of requests that are requested by that entity that are under a budget “B” (e.g., “Pₜ₊₁=min(aₜ₊₁, B)”), entities do not request an amount of computing resources that are equal to the budget. In an absence of a cost of provisioning compute by the entity, even a small probability that an amount of computing resources desired is greater than or equal to the budget implies that entity is motivated to ask for an amount of computing resources equal to the budget. Therefore, since this scenario is not observed in the real world, a cost of provisioning compute is non-zero. Since this cost can be an implicit cost, this cost varies across entities. Hence, the instantaneous reward function “r(s, a, s′)=some function g(Dₜ₊₁, Pₜ₊₁, c)” is dependent on an entity-specific parameter “c” which can be thought of as cost of starting the provisioned compute. This parameter is modelled as the entity resource model 150 which is then used to evaluate a change under a different allocation mechanism. In this example, “r(s, a, s′)=g(Dₜ₊₁, Pₜ₊₁, c)=Pr(Dₜ₊₁<=Pₜ₊₁)−c*Pₜ₊₁.”

Accordingly, the entity model generation module 308 estimates this parameter by finding a value of “c” that maximizes an instantaneous reward “r(s, a, s′)” under the first allocation mechanism 144 as part of generating the entity resource model 150. Once this is done, the simulation module 310 simulates behaviour of the entity under different allocation mechanisms, e.g., the second allocation mechanism 148 using this value of “c” as defined by the entity resource model 150.

When the allocation mechanism changes, state transition probabilities “Pr(s′|s, a)” as well as the instantaneous reward function “r(s, a, s′)” change because “Pₜ₊₁” has changed. The following technique is usable by the state valuation module 512 to estimate state valuations 514 under the second allocation mechanism 148:
1. Provisioning P is given by mechanism: f(sₜ, aₜ₊₁);
2. Compute transition probability matrix between states: Pr(sₜ₊₁|sₜ, aₜ₊₁)=Pr(sₜ₊₁=uₜ₊₁|uₜ, aₜ₊₁)=Pr(Dₜ₊₁=uₜ₊₁*Pₜ₊₁|uₜ, aₜ₊₁)
3. Compute instantaneous rewards r(sₜ, aₜ₊₁, sₜ₊₁)=Pr(Dₜ₊₁<=Pₜ₊₁)−c*Pₜ₊₁
4. Perform value iteration to find state valuations. For each state s:
   a. V(s)=0
   b. Until convergence:
      i. Set V(s)=max_{a∈A} [r(s, a, s′)+γΣ_{s′}P(s′|s, a)*V(s′)]//At convergence, these are the final valuations of each state.

The simulation module 310 then simulates entity behaviour using the state valuations 514. An output of this simulation is used by the efficiency evaluation module 518 to understand the effect on wastage criterion 520 and average resource utilization 522.

An example of steps performed by the simulation module 310 in performing the simulation include the following:
Start at initial state so, e.g., 0.5. Then u₀=0.5 also.
For a selected time period “t”:
   Entity asks for a*=argmax_{a_t+1}r(sₜ, aₜ₊₁, sₜ₊₁)+Σ_sₜ₊₁γ*Pr(sₜ₊₁|sₜ, aₜ₊₁)*V(sₜ₊₁), where sₜ₊₁ are states that can be reached after performing action aₜ₊₁ from state sₜ, and V(sₜ₊₁) is computed earlier;
   Provision “P” virtual tokens 208 per the second allocation mechanism being tested;
   Next “state sₙₑₓₜ=conditional draw” from transition probability matrix given provisioning; completing one time period.
   Repeat with new “+s=s_ₙₑₓₜ” to obtain results for additional time periods.
      The efficiency evaluation module 518 then computes a wastage criterion 520 as an average wastage of credits and also computes average user utilization 522 which are output as evaluation data 312.

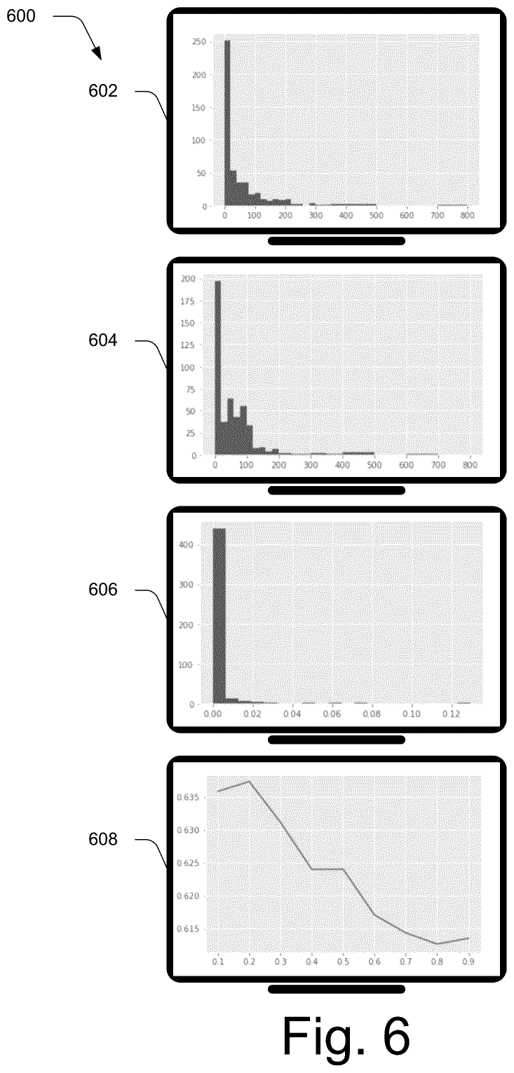

FIG. 6 depicts an example implementation 600 of output of the evaluation data of FIG. 5 in a user interface. In a first example 602, evaluation data 312 is output showing frequency of entities on a Y axis and average virtual tokens used by an entity in a respective time period along the X axis. In a second example 604, evaluation data 312 is output showing frequency of entities on a Y axis and a standard deviation of virtual tokens used by an entity in a respective time period along the X axis. In a third example 606, evaluation data 312 is output showing frequency of entities on a Y axis and a value of “c” along the X axis. In a fourth example 608, evaluation data 312 is output showing variation in wastage of virtual tokens for different values of a discount factor in the Bellman equation.

Accordingly, the technique described herein support efficient allocation mechanism for computing resources. Testing techniques are provided that support testing of alternative allocation mechanisms before deployment. These techniques include evaluating an effect of the allocation mechanisms on wastage and entity utilization.

### Example System and Device

FIG. 7 illustrates an example system generally at 700 that includes an example computing device 702 that is representative of one or more computing systems and/or devices that implement the various techniques described herein. This is illustrated through inclusion of the computing resource allocation system 130. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interface 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware element 710 that is configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, entity resource usage data describing computing resource usage of an executable service platform by an entity as part of a first allocation generated using a first allocation mechanism;
generating, by the processing device, an entity resource model based on the entity resource usage data of the computing resource usage of the executable service platform as part of the first allocation mechanism;
simulating, by the processing device, computing resource usage of the executable service platform by the entity as part of a second allocation mechanism based on the entity resource model and the entity resource usage data;
estimating, by the processing device, a second allocation to provide to the entity based on the simulating; and
outputting, by the processing device, the second allocation to control access by the entity to the computing resources of the executable service platform.

2. The method as described in claim 1, wherein generating of the entity resource model is based at least in part on the entity resource data that further describes an amount of computing resource usage requested by the entity and amount of computing resource usage used by the entity.

3. The method as described in claim 2, wherein the amount of computing resource usage requested by the entity and amount of computing resource usage used by the entity is specified using virtual tokens.

4. The method as described in claim 1, wherein generating of the entity resource model is based at least in part on the entity resource data that further describes an amount of computing resources made available by the first allocation using the first allocation mechanism.

5. The method as described in claim 4, wherein the amount of computing resources made available is specified using virtual tokens.

6. The method as described in claim 1, wherein the entity resource model is configured based on a cost of starting the computing resource usage of the computing resources of the executable service platform by the entity.

7. The method as described in claim 1, wherein the simulating is performed as corresponding to a future time interval.

8. The method as described in claim 1, further comprising evaluating efficiency of the second allocation mechanism based on the simulating and wherein the estimating the second allocation is based on the evaluating.

9. The method as described in claim 8, wherein the evaluating is based on a wastage criterion or average resource utilization.

10. The method as described in claim 1, wherein the estimating the second allocation to provide to the entity is performed using machine learning.

11. The method as described in claim 10, wherein the machine learning includes reinforcement learning.

12. A system comprising:
a usage data input module implemented by a processing device to receive entity resource usage data describing usage of virtual tokens to employ computing resources of an executable service platform by an entity, the virtual tokens made available to the entity as part of a first allocation generated using a first allocation mechanism;
an entity model generation module implemented by the processing device to generate an entity resource model based on the entity resource usage data of the usage of the virtual tokens as part of the first allocation mechanism;
a simulation module implemented by the processing device to simulate usage of virtual tokens by the entity as part of a second allocation mechanism based on the entity resource model and the entity resource usage data; and
a resource allocation module to estimate a second allocation to provide to the entity based on the simulation.

13. The system as described in claim 12, wherein the entity model generation module is configured to generate the entity resource model based at least in part on the entity resource data that further describes an amount of virtual token requested by the entity and an amount of virtual tokens used by the entity.

14. The system as described in claim 12, wherein the entity model generation module is configured to generate the entity resource model based at least in part on the entity resource data that further describes an amount of virtual tokens made available by the first allocation using the first allocation mechanism.

15. The system as described in claim 12, wherein the entity resource model is configured based on a cost of starting the computing resource usage of the computing resources of the executable service platform by the entity.

16. The system as described in claim 12, wherein the simulation module is configured to simulate a future time interval.

17. The system as described in claim 12, further comprising a mechanism evaluation module configured to evaluate efficiency of the second allocation mechanism based on the simulation.

18. The system as described in claim 17, wherein the mechanism evaluation module employs a wastage criterion or average resource utilization.

19. One or more computer-readable storage media storing instructions that, responsive to execution by a processing device, causes the processing device to perform operations including:
receiving entity resource usage data describing computing resource usage of an executable service platform by an entity as part of a first allocation generated using a first allocation mechanism;
generating an entity resource model based on the entity resource usage data of the computing resource usage of the executable service platform as part of the first allocation mechanism;
simulating computing resource usage of the executable service platform by the entity as part of a second allocation mechanism based on the entity resource model and the entity resource usage data;
estimating a second allocation to provide to the entity based on the simulating using a machine learning module; and
outputting the second allocation to control access by the entity to the computing resources of the executable service platform.

20. The one or more computer-readable storage media as described in claim 19, wherein the machine learning includes reinforcement learning.
